(19) United States
(12) Patent Application Publication
(10) Pub. No.: US 2007/0156705 A1
(43) Pub. Date: Jul. 5, 2007

(54) Network Scanner And Network Scanning System

(75) Inventor: Seiji Tsuya, Nagoya-shi, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 11/614,876

(22) Filed: Dec. 21, 2006

(30) Foreign Application Priority Data
Dec. 23, 2005 (JP) 2005-371189

(51) Int. Cl. G06F 17/30

(52) U.S. Cl. 707/10

(57) ABSTRACT

A network scanner is connected to a personal computer via a network. The network scanner includes a specification folder into which the personal computer stores a specification data, a reading unit that scans an original in accordance with the specification data read from the specification folder so as to obtain a scanned data, and an image folder that stores the scanned data. The personal computer accesses the network scanner to obtain the scanned data from the image folder.

### CROSS REFERENCE TO RELATED APPLICATION

This application claims priority from Japanese Patent Application No. 2005-371189 filed Dec. 23, 2005. The entire content of this priority application is incorporated herein by reference.

### TECHNICAL FIELD

The disclosure relates to a network scanner and a network scanning system for scanning an original.

### BACKGROUND

As advances are being made in networking personal computers, workstations, and the like, recently network scanning systems are being constructed to connect a network scanner and a personal computer via the network. In a conventional network scanning system, typically a scanner driver is installed on a personal computer connected to a network scanner via the network. To scan an original, the personal computer connects to the network scanner through the network and specifies a scan mode of the network scanner. The network scanner reads the original and transmits scanned image data to the personal computer, whereupon the personal computer processes the image data as needed and outputs the data to the source application program (see Japanese unexamined patent application publication No. 2005-223759, for example)

However, since the personal computer issues the scan command to the network scanner and processes the resulting scanned image data in this conventional network scanning system, the user must install a scanner driver on the personal computer in order to output the scanned data processed according to the user's instructions to an application program on the personal computer. Such installation can be time-consuming when creating a network system in which a plurality of personal computers is connected to the network scanner via the network.

### SUMMARY

In view of the foregoing, it is an object of the invention to provide a network scanner and a network scanning system enabling a personal computer to acquire scanned data generated by the network scanner according to the user's instructions, without requiring a scanner driver installed on the personal computer.

In order to attain the above and other objects, the invention provides a network scanner including: a first network folder that stores a specification data; a reading unit that reads the specification data from the first network folder; a scanning unit that scans an original in accordance with the specification data read from the first network folder, thereby obtaining a scanned data; a second network folder; and a storage controlling unit that stores the scanned data into the second network folder.

There is also provided a network scanning system including a scanner that scans an original, a storage device connected to the scanner, and a terminal device that is connected to the storage device via a network. The external storage device includes: a first network folder that stores a specification data; a reading unit that reads the specification data from the first network folder; a scan controlling unit that controls the scanner to scan the original in accordance with the specification data read from the first network folder, thereby obtaining a scanned data; a second network folder; and a storage controlling unit that stores the scanned data into the second network folder. The terminal device includes a specification data inputting unit that stores the specification data into the first network folder via the network.

### BRIEF DESCRIPTION OF THE DRAWINGS

Illustrative aspects in accordance with the invention will be described in detail with reference to the following figures wherein:

FIG. 1 is a block diagram showing the structure of a network scanning system according to a first illustrative aspect of the invention;

FIG. 2 is a block diagram of a multifunction peripheral employed in the network scanning system of FIG. 1;

FIG. 3 is a conceptual block diagram of the multifunction peripheral of FIG. 2 as a network scanner;

FIG. 4 is an explanatory diagram illustrating the structure of a specification file;

FIG. 5 is a block diagram showing the configuration of a network scanning program executed by the multifunction peripheral of FIG. 2;

FIG. 6 is an explanatory diagram illustrating a data block used in a data managing function shown in FIG. 5;

FIG. 7 is a flowchart illustrating steps in a specification file monitoring task shown in FIG. 5;

FIG. 8 is a flowchart illustrating steps in a specification file analyzing task shown in FIG. 5;

FIG. 9 is a flowchart illustrating steps in a scanning task shown in FIG. 5;

FIG. 10 is a flowchart illustrating steps in a scanning results processing task shown in FIG. 5;

FIG. 11 is a flowchart illustrating steps in a scanning results processing task that is executed by a network scanning system according to a second illustrative aspect of the invention;

FIG. 12 is a block diagram showing the structure of a network scanning system according to a third illustrative aspect of the invention;

FIG. 13 is a block diagram of a multifunction peripheral employed in the network scanning system of FIG. 12;

FIG. 14 is a conceptual block diagram showing the multifunction peripheral of FIG. 12 as a scanner, and a network scanner server employed in the network scanning system of FIG. 12;

FIG. 15 is a block diagram showing the configuration of a network scanning system program executed by the network scanner server of FIG. 12; and

FIG. 16 is a flowchart illustrating steps in a scanning task shown in FIG. 15.

### DETAILED DESCRIPTION

Network scanning systems according to some aspects of the invention will be described while referring to the accompanying drawings wherein like parts and components are designated by the same reference numerals to avoid duplicating description.

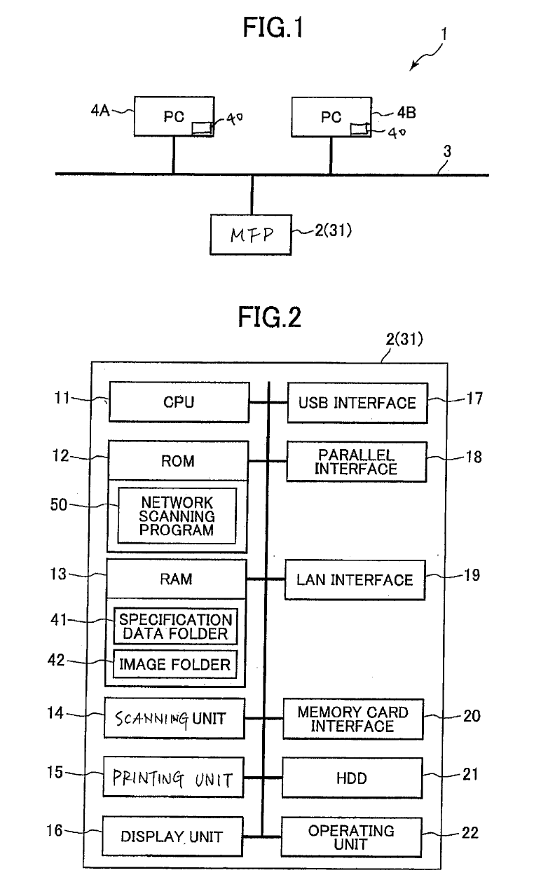

FIG. 1 is a block diagram of a network scanning system 1 according to a first illustrative aspect of the invention. The network scanning system 1 includes a multifunction peripheral (MFP) 2, and a plurality (two in the present example) of personal computers 4A and 4B that are connected to the MFP 2 via a local area network (LAN) 3.

As shown in FIG. 2, the MFP 2 includes a central processing unit (CPU) 11, a read-only memory (ROM) 12, a random-access memory (RAM) 13, a scanning unit 14, a printing unit 15, a display unit 16, a USB interface 17, a parallel interface 18, a (LAN) interface 19, a memory card interface 20, a hard disk drive 21, and an operating unit 22.

The CPU 11 functions to perform various operations and processes. The ROM 12 is a read-only, non-volatile memory and constitutes a part of a main storage device of the MFP 2. The ROM 12 stores various programs including a system program, a network scanning program 50 to be described later, and the like. Note that the network scanning program 50 may be stored in such devices as the hard disk drive 21, a memory card, a storage device connected to the MFP 2, or the like, instead of the ROM 12.

The RAM 13 is a readable and writable volatile memory and constitutes a part of the main storage device of the MFP 2. The RAM 13 functions as a work area and the like for storing programs and intermediate results of data processing. The RAM 13 includes a specification data folder 41 and an image folder 42. The specification data folder 41 is for storing a specification file containing specification data, with the specification file being assigned a filename identifying a user that stored the specification data. More specifically, the filename is created based on a username included in the specification data. The contents of the specification file will be described later. The image folder 42 is for storing scanned data obtained by scanning an original according to the specification data. The image folder 42 is assigned a folder name including a username for identifying the user so that the image folder 42 can be differentiated from other folders.

When the LAN interface 19 outputs a read/write command received from the LAN 3 to the CPU 11, the CPU 11 reads data from or write data to the RAM 13 in accordance with the read/write command and outputs a write-complete signal or read data to the LAN interface 19, which in turn transmits the same to the LAN 3. The specification data folder 41 and the image folder 42 function as network folders to and from which data can be read through the LAN 3.

The scanning unit 14 provides a scanner function for extracting an image described (printed) on paper or film. The CPU 11 controls the scanning unit 14 to scan the image according to the specification data.

The printing unit 15 functions to form monochromatic or color text or images on recording paper. The display unit 16 constitutes a display device of the MFP 2. The display unit 16 may be configured of a simple matrix type liquid crystal display employing an FTN or DSTN system or an active matrix type liquid crystal display employing a TFT system.

The USB interface 17 and the parallel interface 18 function to connect external devices to the MFP 2 so that the MFP 2 can communicate with the external devices.

The LAN interface 19 connects the MFP 2 to the LAN 3 so that the MFP 2 can communicate with other external devices connected to the LAN 3, such as the personal computers 4A and 4B. The memory card interface 20 functions to connect a memory card reading device to the MFP 2 so that communication is possible therebetween.

The hard disk drive 21 is a readable and writable nonvolatile memory. The hard disk drive 21 may function as a work area together with the RAM 13. The operating unit 22 constitutes an input device of the MFP 2 and includes a keyboard with a prescribed number of input keys arranged in rows, a touch panel fixed to the display unit 16, and the like. The operating unit 22 includes a start scan button for initiating a scanning operation on the MFP 2.

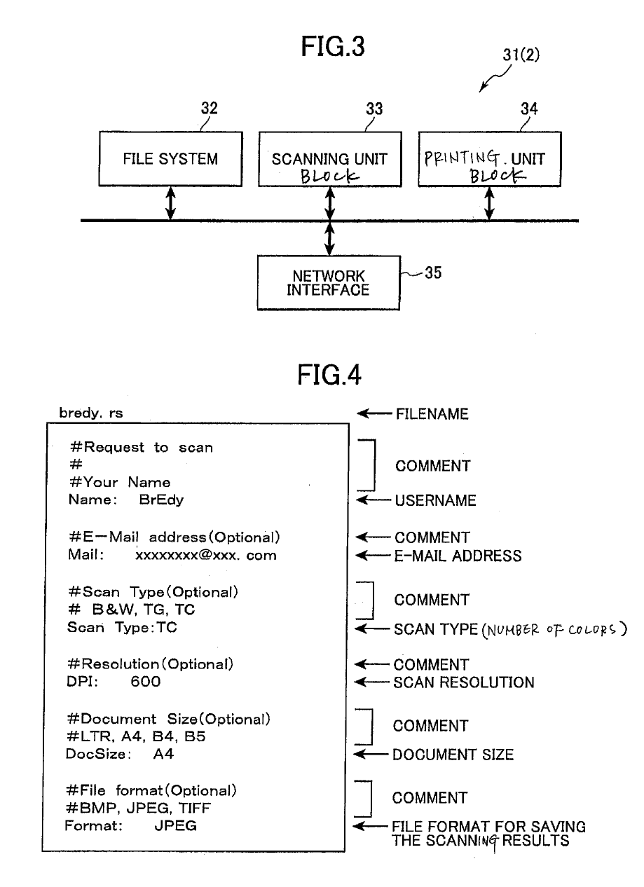

FIG. 3 is a conceptual block diagram of the MFP 2 as a network scanner 31. The network scanner 31 is built into the MFP 2 for giving the MFP 2 a scanner function. The network scanner 31 includes a file system 32, a scanning unit block 33, a printing unit block 34, and a network interface 35. All of these components are configured of the components of the MFP 2 as follows.

The file system :32 is a conceptual feature configured of the RAM 13 in the MFP 2. The scanning unit block 33 is a conceptual feature configured of the CPU 11 and the scanning unit 14 in the MFP 2. The printing unit block 34 is a conceptual feature configured of the CPU 11, the ROM 12, the RAM 13, and the operating unit 22 in the MFP 2. The network interface 35 is a conceptual feature configured of the LAN interface 19 in the MFP 2.

FIG. 4 illustrates the structure of the specification file. As mentioned above, the specification file is given a filename for enabling the MFP 2 or the personal computer 4A or 4B to identify each file. The filename may be a name that enables to identify a user of the file. The specification file stores comments and specification data. The specification data includes a username, an e-mail address, a scan type (number of colors), a scanning resolution, a document size, and a file format for storing scanning results.

The username identifies a user having access privileges for accessing the MFP 2 and acquiring scanned data. The username may be a normal name, a nickname, an ID number, or the like. The e-mail address specifies the destination for issuing a notification after data has been scanned.

The scan type specifies the number of colors in which to scan an original For example, the user can specify a desired resolution from among B&W (black and white), TG (True Gray: 256-Gray-Scale), and TC (True Color: 24bit-color).

The scanning resolution specifies the resolution at which the original is scanned. The scanning resolution can be selected by a user. The document size specifies the size of an original document. The document size can be selected by a user from among letter size, A4-size, B4-size, and B5-size.

The file format indicates the format in which scanning results are saved in a file in the image folder 42. The user can input a desired file format from among JPEG, TIFF, and BMP formats, for example.

Of the specification data stored in the specification file, the username is a required input for identifying the user. However, the e-mail address, the scan type, the scanning resolution, and the document size are optional items that may be inputted according to convenience or individual preference.

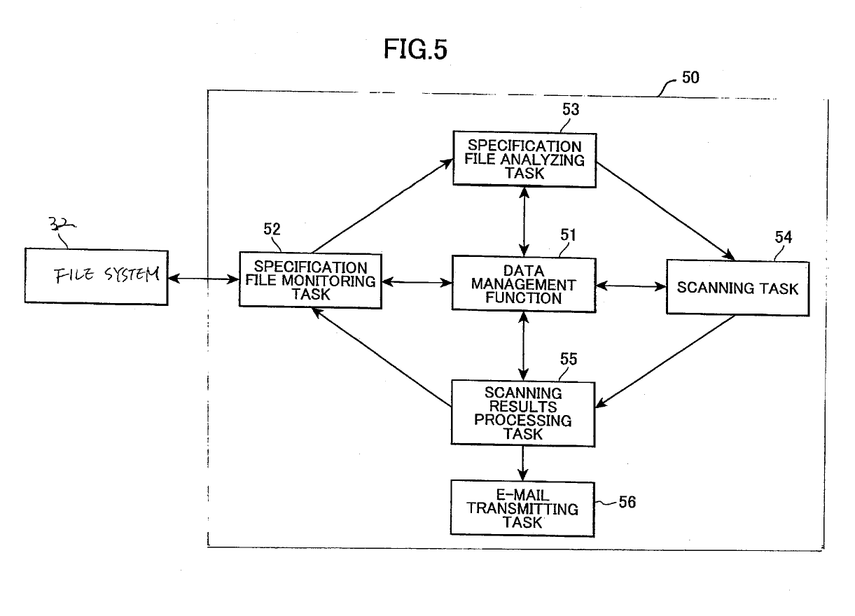

As shown in FIG. 5, executing the network scanning program 50 by the MFP 2 implements a data management function 51, a specification file monitoring task 52, a specification file analyzing task 53, a scanning task 54, a scanning results processing task 55, and an e-mail transmitting task 56.

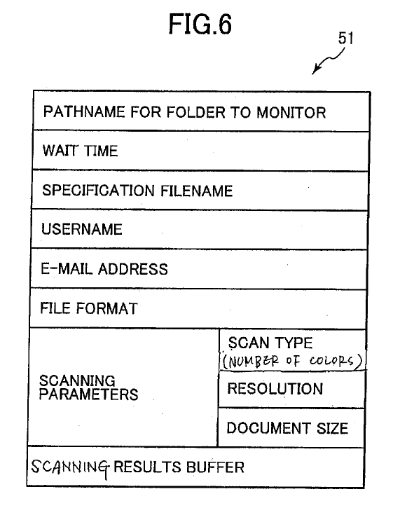

The data management function 51 is data stored in any of such memories as the ROM 12, the RAM 13, the hard disk drive, or the like in the MFP 2 and performs data input/output during an image scanning operation. As shown in FIG. 6, the data management function 51 includes storage fields for storing a pathname for a folder to be monitored, a wait time, a specification filename, the username included in the specification data, the e-mail address included in the specification data, the file format included in the specification data, and scanning parameters (such scanning conditions as scan type (number of colors), scanning resolution, and document size) included in the specification data, as well as a scanning results buffer.

Here, the pathname for a folder to be monitored indicates a pathname of a folder that the NFP 2 monitors to determine whether specification data has been placed therein. Since specification data is placed in the specification data folder 41 by the personal computer 4A or 4B in this illustrative aspect, the pathname of the specification data folder 41 is stored as the pathname of the folder to be monitored.

The wait time indicates a time interval at which the tasks shown in FIG. 5 are executed. Although the wait time is preset to an initial setting, the user can modify the wait time as desired using the operating unit 22. The specification filename is a filename of a specification file storing specification data. When the MFP 2 discovers a specification file containing specification data by searching the specification data folder 41, the MFP 2 stores the filename of the discovered specification file as the specification filename.

The content of the specification file is placed in a username field, an e-mail address field, a file format field, and a scanning parameters field of the data management function 51. The scanning results buffer stores scanned data acquired by scanning an original according to the specification data.

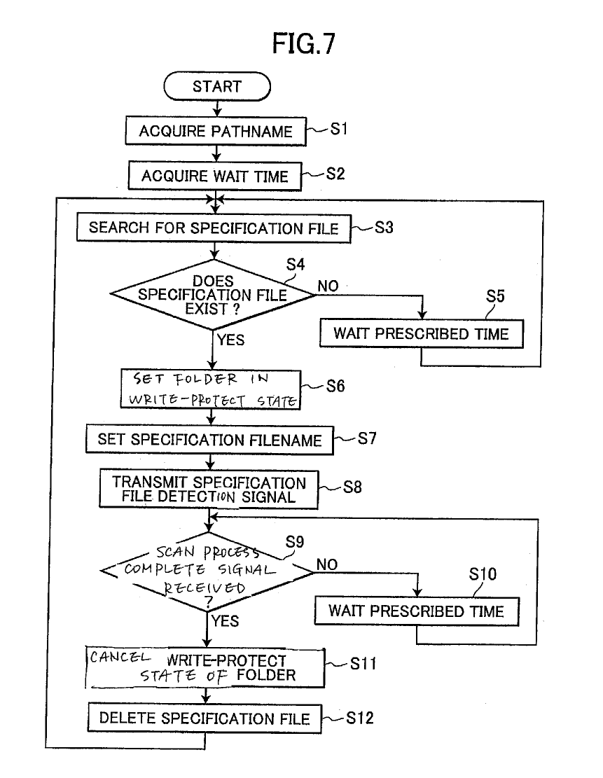

Next, steps in the process of the specification file monitoring task 52 will be described with reference to FIG. 7. The specification file monitoring task 52 functions to acquire specification data from the specification data folder 41.

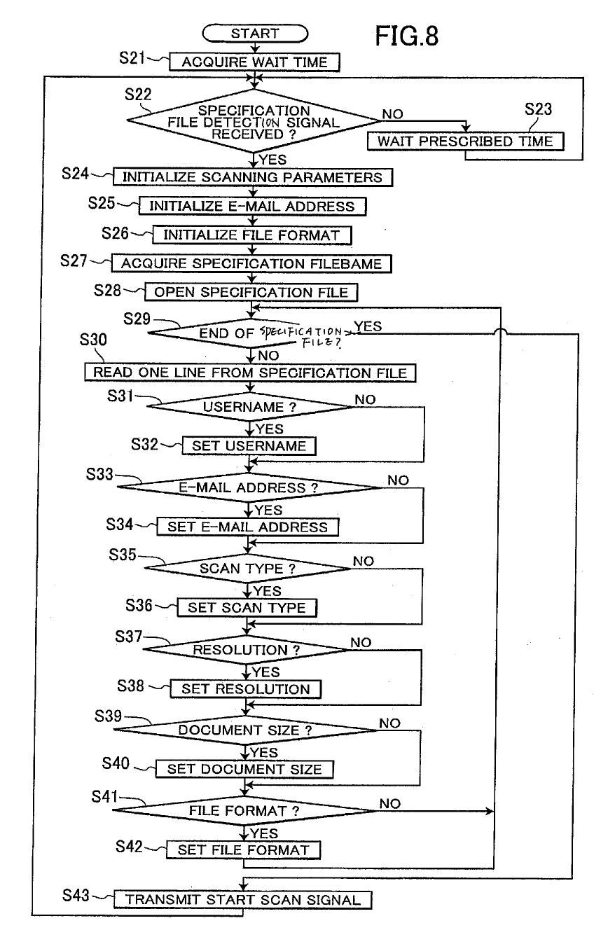

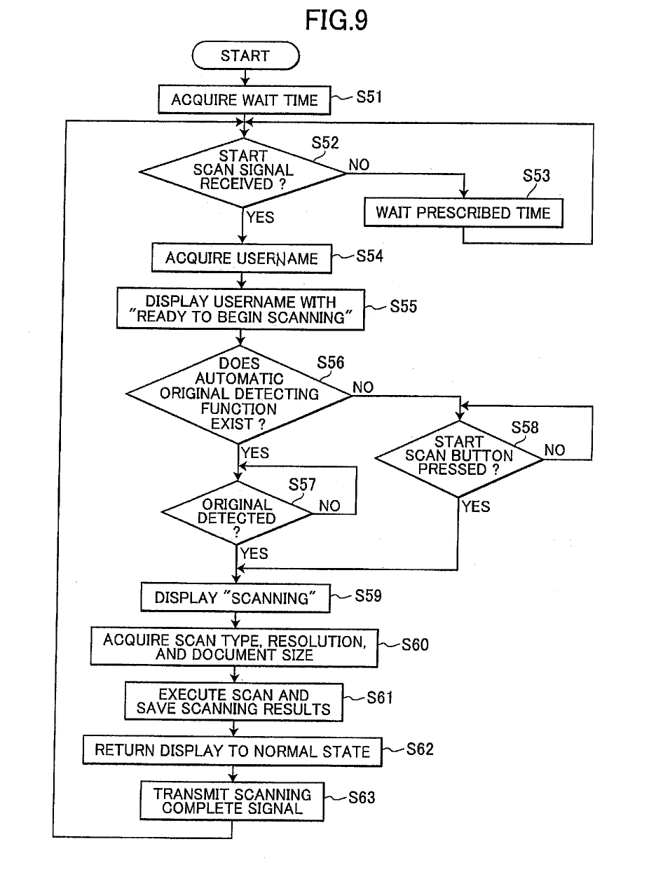

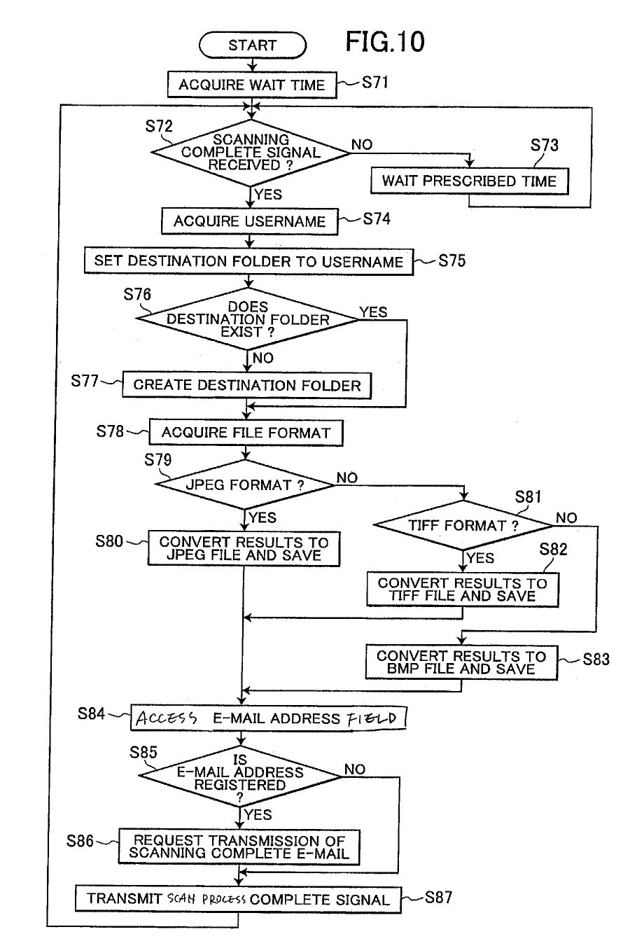

In S1 of FIG. 7, the specification file monitoring task 52 acquires the pathname of the folder to be monitored from the data management function 51. In S2, the specification file monitoring task 52 acquires the wait time from the data management function 51, and in S3, the specification file monitoring task 52 accesses the file system 32 and searches for a specification file containing specification data. In S4, the specification file monitoring task 52 determines whether or not a specification file exists based on the search results. If a specification file does not exist (S4: NO), then the specification file monitoring task 52 waits a prescribed time (wait time acquired in S2) in S5 and subsequently returns to S3. The reason the specification file monitoring task 52 waits for a prescribed time in S5 is to ensure that the scanning function does not interfere with other functions in the MFP 2. In processes described later (S10 of FIG. 7, S23 of FIG. 8, S53 of FIG. 9, and S73 of FIG. 10), the prescribed wait time is provided for the same reason.

However, if a specification file exists (S4: YES), then in S6, the specification file monitoring task 52 sets the folder being monitored in a write-protect state. In S7, the specification file monitoring task 52 stores a specification filename for the specification file found in S3 into the data management function 51 as the specification filename. In S8, the specification file monitoring task 52 transmits a specification-file detection signal to the specification file analyzing task 53.

In S9, the specification file monitoring task 52 determines whether or not a scan process complete signal has been received from the scanning results processing task 55. If not (S9: NO), then the specification file monitoring task 52 waits a prescribed time in S10 and subsequently returns to S9.

On the other hand, if so (S9: YES), then in S11, the specification file monitoring task 52 cancels the write-protect state of the folder to be monitored. In S12, the specification file monitoring task 52 deletes the specification file indicated by the specification filename that was stored in the data management function 51 in S7 and returns to S3.

Next, steps in the process of the specification file analyzing task 53 will be described with reference to FIG. 8. The specification file analyzing task 53 functions to analyze specification data detected by the specification file monitoring task 52 and to extract conditions for scanning an original.

In S21 of FIG. 87 the specification file analyzing task 53 acquires the wait time from the data management function 51 In S22, the specification file analyzing task 53 determines whether a specification-file detection signal has been received from the specification file monitoring task 52 If not (S22: NO), then the specification file analyzing task 53 waits a prescribed time in S23 and returns to S22.

On the other hand, if so (S22: YES), then the specification file analyzing task 53 initializes the scanning parameters of the data management function 51 in S24, initializes the e-mail address in the data management function 51 to a null string in S25, and initializes the file format of the data management function 51 in S26.

In S27, the specification file analyzing task 53 acquires the specification filename from the data management function 51 and in S28 opens a specification file indicated by the specification filename that was acquired in S27. In S29, the specification file analyzing task 53 determines whether the end of the specification file has been reached. If not (S29: NO), then in S30, the specification file analyzing task 53 reads one line from the specification file. In S31, the specification file analyzing task 53 determines whether the data read in S30 is data for the username. If not (S31: NO), the specification file analyzing task 53 advances to S33. On the other hand, if so (S31: YES), then the specification file analyzing task 53 acquires the username from the data read in S30 and sets the username field in the data management function 51 to this username in S32. Subsequently, the specification file analyzing task 53 advances to S33.

In S33, the specification file analyzing task 53 determines whether the data read in S30 is the e-mail address. If not (S33: NO), then the specification file analyzing task 53 advances to S35. On the other hand, if so (S33: YES), then the specification file analyzing task 53 acquires the e-mail address from the data read in S30 and sets the e-mail address field in the data management function 51 to this e-mail address in S34. Subsequently, the specification file analyzing task 53 advances to S35.

In S35, the specification file analyzing task 53 determines whether the data read in S30 is the scan type. If not (S35: NO), then the specification file analyzing task 53 advances to S37. On the other hand, if so (S35: YES), then the specification file analyzing task 53 acquires the scan type from the data read in S30 and sets the scan type field in the data management function 51 to this scan type in S36. Subsequently, the specification file analyzing task 53 advances to S37.

In 537, the specification file analyzing task 53 determines whether the data read in S30 is the scanning resolution. If not (S37: NO), the specification file analyzing task 53 advances to S39. On the other hand, if so (S37: YES), then the specification file analyzing task 53 acquires the scanning resolution from the data read in S30 and sets the scanning resolution field in the data management function 51 to this scanning resolution in S38. Subsequently, the specification file analyzing task 53 advances to S39.

In S39, the specification file analyzing task 53 determines whether the data read in S30 is the document size. If not (S39: NO), then the specification file analyzing task 53 advances to S41. On the other hand, if so (S39: YES), then the specification file analyzing task 53 acquires the document size from the data read in S30 and sets the document size field in the data management function 51 to this document size in S40. Subsequently, the specification file analyzing task 53 advances to S41.

In S41, the specification file analyzing task 53 determines whether the data read in S30 is the file format. If not (S41: NO), the specification file analyzing task 53 returns to S29 On the other hand, if so (S41: YES), then the specification file analyzing task 53 acquires the file format from the data read in S30 and sets the file format field in the data management function 51 to this file format in S42. Subsequently, the specification file analyzing task 53 returns to S29.

In S29, the specification file analyzing task 53 again determines whether the end of the specification file has been reached. The specification file analyzing task 53 repeats the process of S29-S42 until data has been read to the end of the specification file. When the specification file analyzing task 53 determines that the end of the file has been reached (S29: YES), then in S43, the specification file analyzing task 5.3 transmits a start scan signal to the scanning task 54. Subsequently, the specification file analyzing task 53 returns to S22 and waits.

Next, steps in the process of the scanning task 54 will be described with reference to FIG. 9. The scanning task 54 functions to scan an original according to the specification data.

In S51 of FIG. 9, the scanning task 54 acquires the wait time from the data management function 51. In S52, the scanning task 54 determines whether a start scan signal has been received from the specification file analyzing task 53. If not (S52: NO), then the scanning task 54 waits the prescribed time in S53 and returns to S52.

On the other hand, if so (S52: YES), then in S54, the scanning task 54 acquires the username from the data management function 51. In S55, the scanning task 54 displays the username together with a message “Ready to begin scanning operation” on the display unit 16.

In S56, the scanning task 54 determines whether a function is provided for automatically detecting an original when an original is set to the scanning unit 14. If so (S56: YES), then in S57, the scanning task 54 confirms whether an original has been detected. If not (S57: NO), then the scanning task 54 waits until an original has been detected. On the other hand, if so (S57: YES), then the scanning task 54 advances to S59.

However, if the scanning task 54 determines in S56 that the function for automatically detecting an original is not present (S56: NO), then in S58, the scanning task 54 determines whether the start scan button of the operating unti 11 has been pressed If not (S58: NO), then the scanning task 54 waits until the start scan button has been pressed. On the other hand, if so (S58: YES), the scanning task 54 advances to S59.

In S59, the scanning task 54 displays “Scanning” on the display unit 16. In S60, the scanning task 54 acquires the scanning parameters (that is, the scan type (number of colors), the scanning resolution, and the document size) from the data management function 51. In S61, the scanning task 54 executes a scanning operation according to the parameters acquired in S60 and saves scanning results in the scanning results buffer of the data management function 51.

In S62, the scanning task 54 returns the display unit 16 to the normal display state. In S63, the scanning task 54 transmits a scanning complete signal to the scanning results processing task 55. Subsequently, the scanning task 54 returns to S52 and waits.

Next, steps in the process of the scanning results processing task 55 will be described with reference to FIG. 10. The scanning results processing task 55 functions to save the scanned data in the image folder 42 according to the user-specified file format.

In S71 of FIG. 10, the scanning results processing task 55 acquires the wait time from the data management function 51. In S72, the scanning results processing task 55 determines whether a scanning complete signal has been received from the scanning task 54. If not (S72: NO), then the scanning results processing task 55 waits the prescribed time in S7.3 and returns to S72.

On the other hand, if so (S72: YES), then in S74, the scanning results processing task 55 acquires the username from the data management function 51 and sets, in S75, a destination folder name to the username acquired in S74. In S76, the scanning results processing task 55 confirms whether or not a destination folder having the destination folder name set in S75 exists in the image folder 42. If so (S76: YES), then the scanning results processing task 55 advances to S78. On the other hand, if not (S76: NO), then in S77, the scanning results processing task 55 creates, in the image folder 42, a destination folder having the destination folder name set in S75, and then advances to S78.

In S78, the scanning results processing task 55 acquires the file format from the data management function 51. In S79, the scanning results processing task 55 determines whether the file format acquired in S78 is the JPEG format. If so (S79: YES), then in S80, the scanning results processing task 55 converts the scanning results saved in the data management function 51 to a JPEG file and saves the JPEG file in the destination folder. Subsequently, the scanning results processing task 55 advances to S84.

On the other hand, if not (S79: NO), then in 581, the scanning results processing task 55 determines whether the file format acquired in S78 is the TIFF format. If so (S81: YES), then in S82 the scanning results processing task 55 converts the scanning results saved in the data management function 51 to a TIFF file and saves the TIFF file in the destination folder. Subsequently, the scanning results processing task 55 advances to S84.

On the other hand, if not (S81: NO), then in S83, the scanning results processing task 55 converts the scanning results stored in the data management function 51 to a BMP file and saves the BMP file to the destination folder. Subsequently, the scanning results processing task 55 advances to S84.

In S84, the scanning results processing task 55 accesses the e-mail address field of the data management function 51i. In S85, the scanning results processing task 55 determines whether an e-mail address has been registered in the data management function 51. If not (S85: NO), the scanning results processing task 55 advances to S87. On the other hand, if so (S85: YES), then in S86, the scanning results processing task 55 requests, by transmitting a request signal, the e-mail transmitting task 56 to transmit a scanning complete e-mail message and advances to S87.

In S87, the scanning results processing task 55 transmits a scan-process complete signal to the specification file monitoring task 52. Subsequently, the scanning results processing task 55 returns to S72 and waits.

Next, the operations of the network scanning system 1 will be described.

When first powered ON, the MFP 2 executes the network scanning program 50. Consequently, the MFP 2 detects the pathname of the specification data folder 41, that is a folder to be monitored, and stores the pathname in the pathname field of the data management function 51. Since each of the personal computers 4A and 4B connected to the MFP 2 via the LAN 3 and capable of acquiring scanned data can provide a specification file in the specification data folder 41, the search domain for specification data is indicated by storing the pathname of the specification data folder 41 in the data management function 51. The MFP 2 acquires the wait time stored in the data management function 51 (S1, S2 in FIG. 7), and then, the MFP 2 enters a standby state after acquiring the pathname for the folder to be monitored and the wait time.

At prescribed intervals, the MFP 2 searches the specification data folder 41 for a specification file and determines whether a specification file containing specification data exists in the specification data folder 41 (S3 and S4 in FIG. 7). If a specification file and, hence, specification data does not exist in the specification data folder 41, the MFP 2 waits the prescribed wait time before checking again for the existence of a specification file (S4: NO, S5 in FIG. 7).

For example, a user wishing to scan an image creates specification data by inputting a username “BrEdy”, an e-mail address “xxxxxxxx@xxx.com,” a scan type “TC”, a scanning resolution “600 dpi,” a document size “A4”, and a file format “JPEG,” in the user's personal computer 4A using an operation panel 40. After the user transmits this specification data to the MFP 2 via the LAN 3, the MFP 2 receives and stores the specification data in the specification data folder 41.

More specifically, the user creates a filename “bredy.rs” based on the user's username “BrEdy” using the personal computer 4A and saves the specification data in a specification file with the filename “bredy.rs”. Consequently, as shown in FIG. 4, “Name: BrEdy” is written in a line of the specification file following the username comment, “Mail: xxxxxxxx@xxx.com” is written in the line following the e-mail address comment, “Scan Type: TC” is written in the line following the scan type comment, “DPI: 600” is written to the line following the scanning resolution comment, “DocSize: A4” is written to the line following the document size comment, “Format: JPEG” is written to the line following the file format comment.

After confirming that a specification file exists in the specification data folder 41, the MFP 2 sets the specification data folder 41 in a write-protect state, thereby preventing other users from accessing the specification data folder 41 and storing specification data until the scanning process is complete (S4: YES, S6 in FIG. 7).

After storing the filename “bredy.rs” of the detected specification file in the specification filename field of the data management function 51, the MFP 2 transmits the specification-file detection signal from the specification file monitoring task 52 to the specification file analyzing task 53 (S7, S8 in FIG. 7).

After acquiring the wait time from the data management function 51, the specification file analyzing task 53 waits until the specification-file detection signal is received from the specification file monitoring task 52 (S21, S22: NO, S23 in FIG. 8)

Upon receiving the specification-file detection signal, the specification file analyzing task 53 initializes existing scanning parameters (scan type, scanning resolution, document size) stored in the data management function 51, initializes the existing e-mail address to a null string, and initializes the existing file format. Consequently, new scanning parameters, e-mail address, and file format can be written to the data management function 51 (S22: YES, S24, S25, S26 in FIG. 8).

The specification file analyzing task 53 acquires the specification filename “bredy.rs” from the data management function 51 and opens the specification file having this filename in the specification data folder 41. Subsequently, the specification file analyzing task 53 confirms whether the end of the specification file has been reached (S27, S28, S29 in FIG. 8).

Since the end of the specification file has not yet been reached when the specification file is just opened, the specification file analyzing task 53 reads the first line in the specification file (S29: NO, S30 in FIG. 8). The first line in the specification file is not the username but a comment for the username. Therefore, the specification file analyzing task 53 does not set a username, an e-mail address, a scan type, a scanning resolution, a document size, or a file format in the data management function 51, but instead checks whether the end of the specification file has been read (S31: NO, S33: NO, S35: NO, S37: NO, S39: NO, S41: NO, S29 in FIG. 8).

When the specification file analyzing task 53 determines that the data read from the specification file is a username, the specification file analyzing task 53 acquires the username “BrEdy” from the specification file and saves this data to the username field in the data management function 51 (S29: NO, S30, S31: YES, S32 in FIG. 8). Since an e-mail address, a scan type, a scanning resolution, a document size, and a file format are not included in the line containing the username, the specification file analyzing task 53 once again checks whether the end of the specification file has been reached (S33: NO, S35: NO, S37: NO, S39: NO, S41: NO, S29 in FIG. 8).

As with the username, the specification file analyzing task .53 extracts the mail address “xxxxxxxx@xxx.com”, the scan type “TC”, the scanning resolution “600”, the document size “A4”, and the file format “JPEG ” from the specification file and sequentially sets the corresponding fields in the data management function 51 to these values (S:33: YES, S34, S35: YES, S36, S37: YES, S38, S39: YES, S40, S41: YES, S42 in FIG. 8).

After reading the end of the specification file containing the file format “JPEG”, the specification file analyzing task 53 transmits the start scan signal to the scanning task 54 indicating that analysis of the specification file is complete (S29: YES, S43 in FIG. 8).

After acquiring the wait time from the data management function 51, the scanning task 54 waits until the start scan signal is received (S51, S52: NO, S53 in FIG. 9).

Upon receiving the start scan signal, the scanning task 54 acquires the username “BrEdy ” stored in the data management function 51 and displays this username together with the message “Ready to begin scanning” on the display unit 16 of the MFP 2 (S52: YES, S54, S55 in FIG. 9). In this way, a third party can recognize when the user having the username “BrEdy” is performing a scanning operation, even when the personal computer 4A of the user is distant from the MFP 2 and the user is not near the MFP 2.

The MFP 2 may or may not have a function for automatically detecting an original document set in the scanning unit 14. If the MFP 2 does not have this function, the user walks to the installed location of the MFP 2, sets the original in the scanning unit 14, and presses the start scan button in the operating unit 22 to initiate the scanning operation (S56: NO, S58: YES in FIG. 9).

However, if the MFP 2 has this function, then the MFP 2 automatically begins the scanning operation after the user has set the original in the scanning unit 14 of the MFP 2 (S56: YES, S57: YES in FIG. 9).

When the scanning operation begins, the MFP 2 displays “Scanning” on the display unit 16 to notify the user that the scanning operation has begun (S59 in FIG. 9). At this time, the MFP 2 reads the scanning parameters, that is, the scanning type “TC”, the scanning resolution “600”, and the document size “A4, specified by the user from the data management function 51 and directs the scanning unit 14 to scan the original according to the scanning parameters. Then, the MFP 2 saves the scanning results (scanned data) in the scanning results buffer of the data management function 51 (S60, S61 in FIG. 9). After all scanned data has been saved in the data management function 51, the MFP 2 returns the display unit 16 to its normal state, notifying that the scanning has completed (S62 in FIG. 9). Subsequently, the MFP 2 transmits the scanning complete signal to the scanning results processing task 55, indicating that the scanning operation is completed (S63 in FIG. 9).

The scanning task 54 has been described above for cases in which one sheet of an original is scanned. However, when scanning a plurality of sheets of an original, the display on the display unit 16 may be changed after each sheet of the original is scanned Further, if the MFP 2 includes an ADF mechanism and scans a plurality of sheets of an original from the ADF mechanism, the display on the display unit 16 can be returned to the normal state after all sheets have been read.

After acquiring the wait time from the data management function 51, the scanning results processing task 55 waits until the scanning complete signal has been received (S71, S72: NO, S73 in FIG. 10).

Upon receiving the scanning complete signal, the scanning results processing task 55 reads the username “BrEdy” from the data management function 51 and sets the destination folder name to the acquired username “BrEdy” (S72: YES, S74, S75 in FIG. 10) The scanning results processing task 55 determines whether or not a folder having the same folder name as the destination folder name “BrEdy” is saved in the RAM 13 or the hard disk drive 21 of the MFP 2 (S76 in FIG. 10). If a folder having this name does not exist, then the scanning results processing task 55 creates an image folder 42 as the destination folder in the RAM 13 and attaches the destination name “BrEdy” to the image folder 42. Subsequently, the scanning results processing task 55 acquires the file format “JPEG” from the data management function 51 shown in FIG. 6 (S76: NO, S77, S78 in FIG. 10)

However, if an image folder 42 with the same name as the destination folder “BrEdy” exists in the RAM 13, then the scanning results processing task 55 acquires the file format “JPEG” from the data management function 51 without creating a new destination folder (S76: YES, S78 in FIG. 10).

Next, the scanning results processing task 55 determines whether the acquired file format is the JPEG format, the TIFF format, or the BMP format, converts the scanning results to the detected format, and saves the converted data to the destination folder (S79-S83 in FIG. 10). Since “JPEG” is stored in the file format field of the data management function 51 in this case, the scanning results processing task 55 converts the scanned data saved in the scanning results buffer of the data management function 51 to a JPEG file and saves the JPEG file in the image folder 42 having the username “BrEdy” as the destination folder name (S79: YES, S80 in FIG. 10)

The scanning results processing task 55 reads the e-mail address from the data management function 51 and determines whether the thus-read e-mail address is the one which has been registered in the specification file analyzing task 53 (S84, S85 in FIG. 10). If the e-mail address is a null string, the scanning results processing task 55 determines that an e-mail address is not registered in the data management function 51. Therefore, the scanning results processing task 55 transmits the scan-process complete signal to the specification file monitoring task 52 to indicate that the scanning process is completed (S85: NO, S87 in FIG. 10).

If an e-mail address (“xxxxxxxx@xxx.com” address in this case) has been written to the data management function 51, the scanning results processing task 55 determines that an e-mail address is registered in the data management function 51 and is not a null string. Therefore, the scanning results processing task 55 transmits, along with the e-mail address xxxxxxxx@xxx.com,” the request signal requesting the e-mail transmitting task 56 to transmit the scanning complete e-mail. Subsequently, the scanning results processing task 55 transmits the scan-process complete signal to the specification file monitoring task 52 (S85: YES, S86, S87 in FIG. 10).

Here, the scanning results processing task 55 may determine whether the character array read from the data management function 51 conforms to the e-mail address format. If the character array does not conform to the e-mail address format, then the scanning results processing task 55 may skip the step requesting the e-mail transmitting task 56 to transmit the scanning complete e-mail and simply transmit the scan-process complete signal to the specification file monitoring task 52. This configuration prevents an error from occurring when the e-mail transmitting task 56 cannot transmit the scanning complete e-mail.

Upon receiving the request to transmit the scanning complete e-mail, the e-mail transmitting task 56 transmits an e-mail message indicating that the scanning operation has completed to the e-mail address “xxxxxxxx@xxx.com” received from the scanning results processing task 55.

After receiving the scanning complete signal from the scanning results processing task 55, the specification file monitoring task 52 cancels the write-protect state of the specification data folder 41, enabling a third party to access the specification data folder 41 and place specification data therein (S9: YES, S11 in FIG. 7). Subsequently, the specification file monitoring task 52 deletes the specification file having the filename “bredy.rs” and ends the scanning operation based on the user's specification data (S12 in FIG. 7).

Upon receiving an e-mail message from the MFP 2 notifying that the scanning process has completed on the MFP 2, the user retrieves the original from the scanning unit 14 of the MFP 2 and returns to the personal computer 4A. The user then accesses the image folder 42 of the MFP 2 from the personal computer 4A via the LAN 3 and transfers the scanned data from the MFP 2 to the personal computer 4A. Since the personal computer 4A can only access the image folder 42 having a folder name that matches the username “BrEdy”, this configuration prevents the user's scanned data from being transferred to the personal computer 4B of another user and, conversely, the scanned data of another user from being transferred to the personal computer 4A.

As described above, the MFP 2 (network scanner 31) reads specification data placed in the specification data folder 41, which serves as a network folder. The scanning unit 14 of the MFP 2 scans an original according to this specification data, and the MFP 2 saves the scanned data in the image folder 42, which serves as a network folder. Therefore, the user can acquire scanned data conforming to the user's specifications on the user's personal computer 4A, without installing a scanner driver on the personal computer 4A.

Note that the specification data folder 41 and the image folder 42 are both not necessarily configured in the RAM 13 of the MFP 2 (network scanner 31), but may be both configured on the hard disk drive 21, or may be configured on separate memory devices. For example, one folder may be configured on the RAM 13, while the other on the hard disk drive 21.

If the MFP 2 is shared by a plurality of users, the desired scanning parameters may vary among users. When a user creates a specification file in the specification data folder 41 including scanning parameters and other specification data for a scanning operation, the MFP 2 scans the original according to the parameters included in the specification data and deletes the specification file from the specification data folder 41 after completing the scanning operation. Therefore, the memory of the MFP 2 is not overloaded with scanning parameters since parameters do not need to be stored on the MFP 2 for each user

Further, data scanned by the scanning unit 14 is stored in the image folder 42 identified by the username “BrEdy” included in the specification data. Therefore, each user can acquire only data scanned according to the user's own specification data.

Further, when the user places specification data in the specification data folder 41 and presses the start scan button on the operating unit 22, the scanning unit 14 begins scanning the original according to the specification data. Accordingly, the user need only walk once from the location of the personal computer 4A to the location of the MFP 2 when performing a scanning operation in order to set the original in the MFP 2. It should be noted that the scanning unit 14 may be configured to automatically start the scanning operation when specification data is placed in the specification data folder 41, without requiring a user to press the start scan button.

Further, when one personal computer 4A places specification data in the specification data folder 41 for scanning an original, another personal computer 45 cannot place specification data in the specification data folder 41, but is prevented from accessing the specification data folder 41. This configuration prevents the scanning unit 14 from scanning the original based on specification data provided by the other personal computer 4B.

Further, when specification data has been placed in the specification data folder 41, the username “BrEdy” for this user (a first user) and the message “Ready to begin scanning” are displayed on the display unit 16 of the MFP 2 to notify others that the MFP 2 is waiting to perform a scanning operation for the first user. This configuration alerts other users that they must wait before setting their originals in the MFP, and prevents the scanning unit. 14 from scanning an original that a second user has set in the scanning unit 14 based on specification data configured by the first user.

Further, the MFP 2 notifies the user at a user-specified e-mail address when the scanning unit 14 has completed scanning an original. Accordingly, if the scanning operation requires a considerable amount of time, for example, when the user sets the scanning resolution to a high resolution of 2400 dpi, the user can leave the MFP 2 and return to the personal computer 4A to perform other work and still be notified on the personal computer 4A side when the scanning operation has completed. At this time, there is no danger that a third party might mistakenly remove the original from the scanning unit 14 since the message “Scanning” is displayed on the display unit 16 of the MFP 2 until the scanning operation has ended.

Next, a network scanning system according to a second illustrative aspect of the invention will be described. The functions, operations, and effects in the second illustrative aspect differ from those in the first illustrative aspect in that the MFP 2 (network scanner 31) attaches an identifier to scanned data before saving the scanned data in a file in the image folder 42. Since the remaining functions, operations, and effects are identical to those described in the first illustrative aspect, only the points of difference will be described below. Further, the following description uses the same reference numerals for components in the structure identical to the first illustrative aspect.

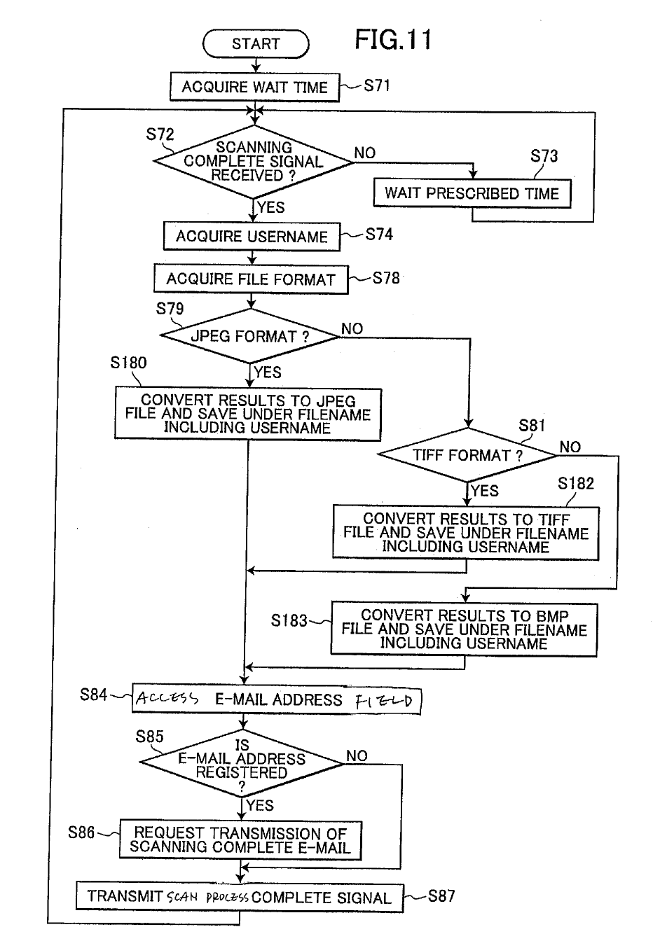

FIG. 11 is a flowchart illustrating steps in the process of a scanning results processing task 155 executed on the network scanning system according to the second illustrative aspect.

After acquiring a username in S74 of FIG. 11, the scanning results processing task 155 acquires a file format from the data management function 51 in S78. If the scanning results processing task 155 determines that the file format is the JPEG format (S79: YES), then in S180, the scanning results processing task 155 converts the scanned results saved in the data management function 51 to a JPEG file and saves the JPEG file in the destination folder(the image folder 42 in this case), under a filename including the username.

However, if the acquired file format is not the JPEG format but the TIFF format (S79: NO, S81: YES), then in S182, the scanning results processing task 155 converts the scanned results saved in the data management function 51 to a TIFF file and saves the TIFF file in the destination folder, under a filename including the username.

If the acquired file format is neither a JPEG format nor a TIFF format (S79: NO, S81: NO), then in S183, the scanning results processing task 155 converts the scanned results saved in the data management function 51 to a BMP file and saves the BMP file in the destination folder, under a filename including the username.

For example, if the user has specified the “JPEG” file format, the MFP 2 (network scanner 31) executing this scanning results processing task 155 first converts the scanned data obtained by scanning an original according to the user's specification data to a JPEG file, and subsequently creates a save file in the image folder 42 assigned a filename that includes the username “BrEdy” and stores the scanned data in the save file. Hence, scanned data for another user is never stored in an existing save file including the username “BrEdy,” and the user can acquire only scanned data scanned according to the user's own specification data by accessing the save file assigned the user's own username “BrEdy.”

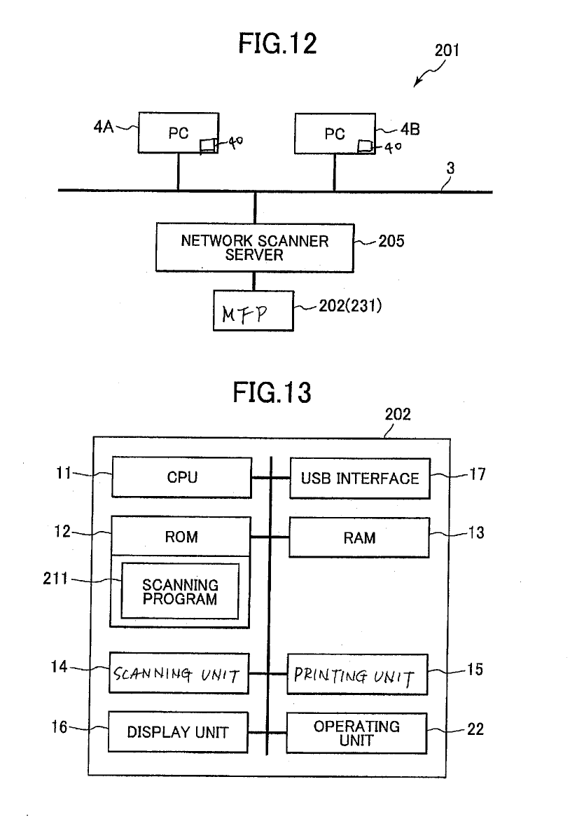

Next, a network scanning system according to a third illustrative aspect of the invention will be described. FIG. 12 is a block diagram showing the structure of a network scanning system 201 according to the third illustrative aspect, which differs from the structures, operations, and effects of the network scanning system 1 according to the first illustrative aspect in the following points. The network scanning system 201 is provided with a network scanner server 205 for externally connecting the specification data folder 41 and the image folder 42 to a multifunction peripheral (MFP) 202 (scanner 231). The network scanner server 205 controls the MFP 202 to scan an original based on specification data. Since the remaining functions, operations, and effects are identical to those described in the first illustrative aspect, only the points of difference will be described below. Further, the following description uses the same reference numerals for components in the structure identical to the first illustrative aspect.

As shown in FIG. 12, in the network scanning system 201, the network scanner server 205 is connected to the personal computers 4A and 4B via the LAN 3. The MFP 202 is connected to the network scanner server 205.

As shown in FIG. 13, the MFP 202 is basically identical to the above-described MFP 2 shown in FIG. 2. However, unlike the MFP 2, the MFP 202 does not include the parallel interface 18, the LAN interface 19, the memory card interface 20, and the hard disk drive 21; and the RAM 13 is not provided with the specification data folder 41 and the image folder 42. Furthermore, unlike the first illustrative aspect, the ROM 12 of the MFP 202 stores a scanning program 211 rather than the network scanning program 50. The scanning program 211 is used for scanning an original set in the scanning unit 14 according to scanning parameters (scan type, scanning resolution, and document size) inputted from the network scanner server 205 and to send scanning results to the network scanner server 205

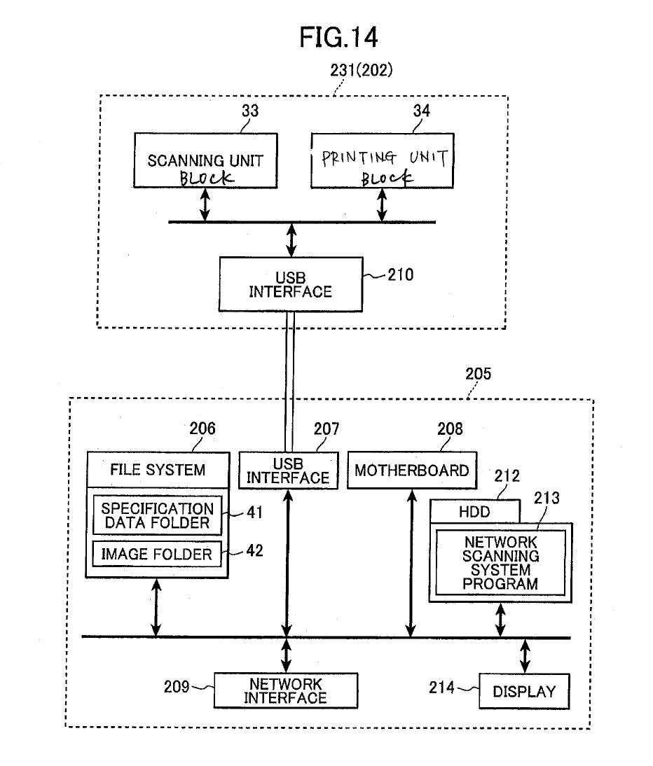

FIG. 14 conceptually shows the MFP 202 as a scanner 231. The scanner 231 includes the scanning unit block 33, the printing unit block 34, and a USB interface 210. The USB interface 210 is configured of the USB interface 17 in the MFP 202 The scanner 231 is connected to the network scanner server 205 via the USB interface 210.

The network scanner server 205 is a common personal computer and, therefore, will not be described in detail herein. However, in order to configure the network scanning system 201, the network scanner server 205 includes a file system 206, a USB interface 207, a motherboard 208, a network interface 209, a hard disk drive 212, and a display unit 214. The specification data folder 41 and the image folder 42 described in the first illustrative aspect are provided in the file system 206. The file system 206 is connected to the LAN 3 via the network interface 209. Hence, the specification data folder 41 and the image folder 42 serve as network folders. The motherboard 208 functions to control the operations of the network scanner server 205. The hard disk drive 212 is a nonvolatile memory that stores programs, data, and the like. In this illustrative aspect, the hard disk drive 212 stores a network scanning system program 213.

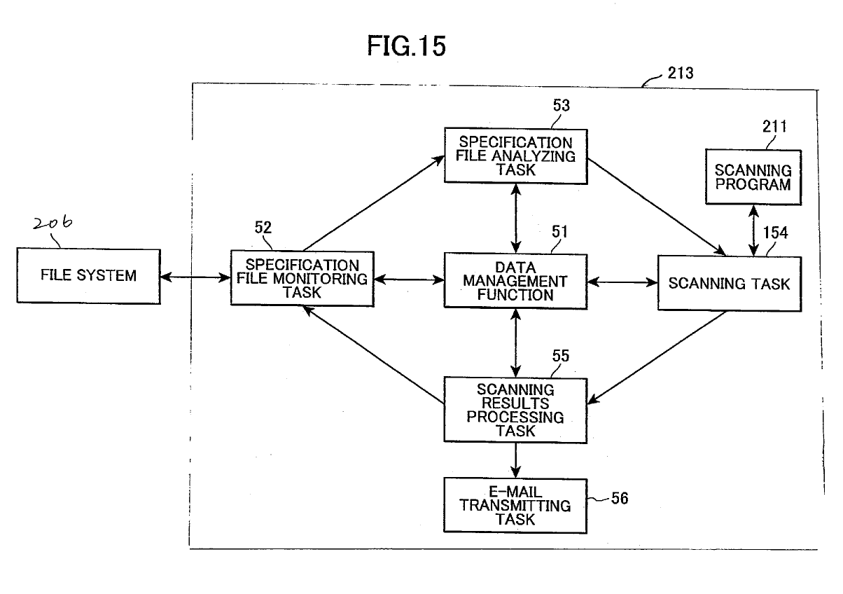

As with the network scanning program 50 in the first illustrative aspect, the network scanning system program 213 shown in FIG. 15 is configured of the data management function 51, the specification file monitoring task 52, the specification file analyzing task 53, a scanning task 154, the scanning results processing task 55, and the e-mail transmitting task 56. The third illustrative aspect differs from the first illustrative aspect in that the network scanner server 205 executes these tasks. Further, unlike the network scanning program 50 in the first illustrative aspect, the network scanning system program 213 stores specification data and scanned data in the specification data folder 41 and the image folder 42, respectively, provided in the file system 206 of the network scanner server 205. Further, the process of the scanning task 154 is different from that of the scanning task 54 in the first illustrative aspect.

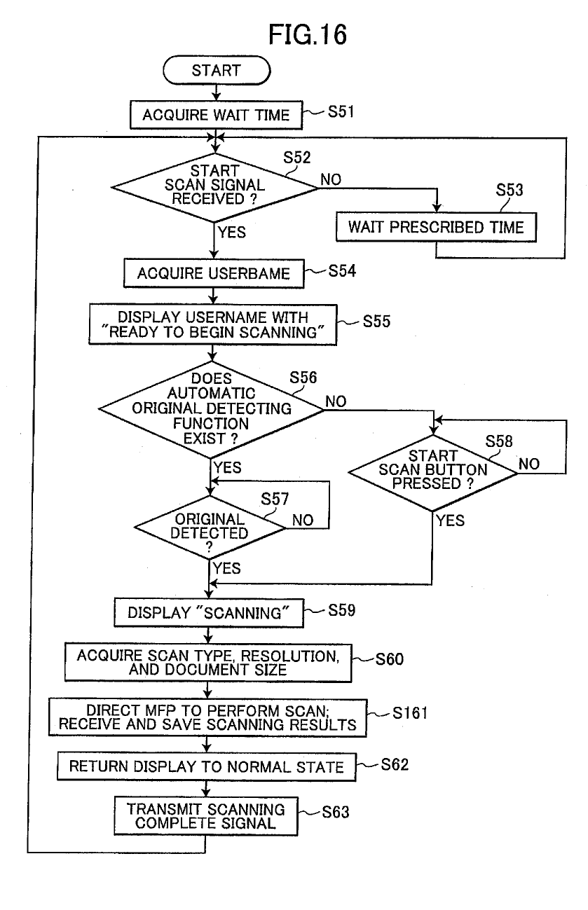

FIG. 16 shows steps in the process of the scanning task 154. The scanning task 154 is executed by the network scanner server 205. The scanning task 154 controls the MFP 202 to scan an original according to user-specified scanning parameters and stores the scanning results.

In S51, the scanning task 154 acquires the wait time from the data management function 51. If the scanning task 154 determines in S52 that the start scan signal has been received from the specification file analyzing task 53 (S52: YES), then in S54, the scanning task 154 acquires the username from the data management function 51. In S55, the scanning task 154 displays the username together with the message “Ready to begin scanning operation” on the display unit 214 of the network scanner server 205.

If the network scanner server 205 has a function for automatically detecting when an original is set to the scanning unit 14 of the MFP 202 (S56: YES), the scanning task 154 advances to S59 when an original is detected in S57. On the other hand, if the network scanner server 205 does not have the function for automatically detecting when an original is set to the scanning unit 14 (S56: NO), then the scanning task 154 advances to S59 after a start scan icon displayed on the display unit 214 of the network scanner server 205 has been mouse-clicked on or the start scan button on the operating unit 22 has been pressed (S58:YES) In S59, the scanning task 154 displays “Scanning” on the display unit 214 of the network scanner server 205. In S60, the scanning task 154 acquires the scanning parameters (scan type, scanning resolution, and document size) from the data management function 51.

In S161, the scanning task 154 directs the MFP 202 to scan an original set in the scanning unit 14 of the MFP 202 based on the scanning parameters acquired in S60, receives scanning results (scanned data) from the MFP 202, and saves the results in the scanning results buffer of the data management function 51. In S62, the scanning task 154 returns the display unit 214 of the network scanner server 205 to the normal display state. In 563, the scanning task 154 transmits the scanning complete signal to the scanning results processing task 55.

With the network scanning system 201 having the structure described above, specification data that the user inputs into the personal computer 4A is placed in the specification data folder 41 provided in the network scanner server 205. The network scanner server 205 reads the specification data from the specification data folder 41 and directs the scanning unit 14 (scanning unit block 33) of the MFP 202 (scanner 231) to scan an original based on the specification data. Since the scanned data scanned by the MFP 202 according to the specification data is inputted into the network scanner server 205 and stored in the image folder 42 (S161 in FIG. 15), the user of the personal computer 4A can acquire the scanned data processed according to the user's specifications without installing a scanner driver on the personal computer 4A.

Here, in this illustrative aspect, the specification data folder 41 and the image folder 42 in the network scanning system 201 are both configured in the same file system 206 of the network scanner server 205. However, these folders may be configured in separate memory devices or separate file systems, or may be configured in the memory devices and file systems of separate devices.

While the invention has been described in detail with reference to the above aspects thereof, it would be apparent to those skilled in the art that various changes and modifications may be made therein without departing from the spirit of the invention.

For example, the MFP 2 and the MFP 202 described above are used as the network scanner 31 and the scanner 231, respectively. However, a device having only a scanner function may also be employed as the network scanner or the scanner

The network in the illustrative aspects is configured of the LAN 3, but may be configured of an internet, a wireless LAN, a USB, a wireless USB, Bluetooth, or the like.

The scanning parameters of the specification data in the illustrative aspects include the scan type, the scanning resolution, and the document size, but may also include the number of sheets of the original to be scanned on the MFP 2 or MFP 202 (network scanner 31 or scanner 231). The user may also be allowed to select between color and monochrome scanning.

In the third illustrative aspect described above, the network scanner server 205 is used as an external storage device. However, the network scanning system may be configured by connecting an external storage device having only a storage unit to the LAN 3 in place of the above-described network scanner server 205. In this case, the data management function 51 stores a pathname of the external storage device as a folder to be monitored.

In the third illustrative aspect described above, the scanning status is displayed on the display unit 214 of the network scanner server 205. However, the scanning status may also be displayed on the display unit 16 of the MFP 202.

What is claimed is:

1. A network scanner comprising:
a first network folder that stores a specification data;
a reading unit that reads the specification data from the first network folder;
a scanning unit that scans an original in accordance with the specification data read from the first network folder, thereby obtaining a scanned data;
a second network folder; and
a storage controlling unit that stores the scanned data into the second network folder.

2. The network scanner according to claim 1, wherein the specification data specifies scanning conditions, and the scanning unit scans the original according to the scanning conditions specified in the specification data.

3. The network scanner according to claim 1, wherein the specification data includes an identifier, and the storage controlling unit attaches the identifier to the scanned data and stores the scanned data attached with the identifier into the second network folder.

4. The network scanner according to claim 1, wherein the specification data includes an identifier, and the storage controlling unit stores the scanned data into the second network folder that is identified by the identifier.

5. The network scanner according to claim 1, further comprising a start command receiving unit that receives a start command, wherein the scanning unit starts scanning the original when the specification data is stored in the first network folder and the start command receiving unit has received the start command.

6. The network scanner according to claim 1, further comprising an access controlling unit that prohibits access to the first network folder when any specification data is stored in the first network folder.

7. The network scanner according to claim 1, further comprising a notifying unit that issues a notification that a scan job is queued when the specification data is stored in the first network folder.

8. The network scanner according to claim 1, further comprising an interface that is connected to an external device via a network and a notifying unit that notifies the external device that scanning is complete when the scanning unit has completed scanning the original, wherein the specification data is stored into the first network folder by the external device via the network.

9. The network scanner according to claim 1, further comprising a deleting unit that deletes the specification data from the first network folder after scanning according to the specification data has completed.

10. A network scanning system comprising:
a scanner that scans an original;
a storage device connected to the scanner, the storage device including:
a first network folder that stores a specification data;
a reading unit that reads the specification data from the first network folder;
a scan controlling unit that controls the scanner to scan the original in accordance with the specification data read from the first network folder, thereby obtaining a scanned data;
a second network folder; and
a storage controlling unit that stores the scanned data into the second network folder; and
a terminal device that is connected to the storage device via a network, the terminal device including a specification data inputting unit that stores the specification data into the first network folder via the network.

11. The network scanning system according to claim 10, wherein the specification data specifies scanning conditions, and the scanning unit scans the original according to the scanning conditions specified in the specification data.

12. The network scanning system according to claim 10, wherein the specification data includes an identifier, and the storage controlling unit attaches the identifier to the scanned data and stores the scanned data attached with the identifier into the second network folder.

13. The network scanning system according to claim 10, wherein the specification data includes an identifier, and the storage controlling unit stores the scanned data into the second network folder that is identified by the identifier.

14. The network scanning system according to claim 10, wherein the storage device further includes a start command receiving unit that receives a start command, wherein the scan controlling unit controls the scanning unit to scan the original when the specification data is stored in the first network folder and the start command receiving unit has received the start command.

15. The network scanning system according to claim 10, wherein the storage device includes an access controlling unit that prohibits other terminal devices from accessing the first network folder when the terminal device has placed the specification data in the first network folder.

16. The network scanning system according to claim 10, wherein the storage device further includes a notifying unit that issues a notification that a scan job is queued when the specification data is stored in the first network folder.

17. The network scanning system according to claim 10, wherein the storage device further includes a notifying unit that notifies the terminal device that scanning is complete when the scanning unit has completed scanning the original.
